(19) United States
(12) Patent Application Publication
(10) Pub. No.: US 2008/0089252 A1
(43) Pub. Date: Apr. 17, 2008

(54) Apparatus and method for protecting receive circuit in time division duplex (TDD) wireless communication system

(75) Inventor: Seong-Keon Choi, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/899,030

(22) Filed: Sep. 4, 2007

(30) Foreign Application Priority Data
Oct. 16, 2006 (KR) 2006-0100236

(51) Int. Cl. H04J 3/00

(52) U.S. Cl. 370/280

(57) ABSTRACT

Apparatus and method for protecting a receive circuit in a Time Division Duplex (TDD) wireless communication system are provided. The apparatus includes a generator for generating a control signal to activate a first amplifier; the first amplifier for receiving an activation signal from the generator; an inverter for inverting the control signal; and a second amplifier for receiving an activation signal from the inverter.

### CROSS-REFERENCE TO RELATED APPLICATION(S) AND CLAIM OF PRIORITY

The present application claims priority under 35 U.S.C. § 119 to an application filed in the Korean Intellectual Property Office on Oct. 16, 2006 and assigned Serial No. 2006-100236, the contents of which are herein incorporated by reference.

### TECHNICAL FIELD OF THE INVENTION

The present invention relates generally to a Time Division Duplex (TDD) wireless communication system, and in particular, to an apparatus and method for protecting a receive circuit in the TDD wireless communication system.

### BACKGROUND OF THE INVENTION

Most wireless communication systems are designed to enable mutual data transmission and reception. To this end, a transmission channel and a reception channel are separated and used based on frequency or time. A transmission and reception channel separation scheme based on frequency is called a Frequency Division Duplex (FDD) and a transmission and reception channel separation scheme based on time is called a Time Division Duplex (TDD).

The FDD scheme communicates by allocating different frequency resources to the transmission channel and the reception channel. By contrast, the TDD scheme allocates the same frequency resource to the transmission channel and the reception channel and communicates by alternating the transmission and the reception over the same frequency resource.

Since the TDD scheme performs the transmission and the reception over a single antenna, a transmitter is physically connected to a receive circuit. Accordingly, a high power signal generated by the transmitter in a transmission interval is likely to be input to the receive circuit. Generally, a receive signal received in a reception interval is very weak compared to the high power signal generated by the transmitter due to the attenuation in the radio channel. Since the receive circuit is designed by taking into account merely the weak receive signal, the receive circuit may be damaged when the high power signal is fed from the transmitter.

FIG. 1 is a block diagram of a conventional communicator in the TDD wireless communication system. The communicator of FIG. 1 includes a Power Amplifier (PA) 101, a duplexer 103, a switch 105, and a Low Noise Amplifier (LNA) 107.

The PA 101 amplifies the transmit signal and outputs the amplified transmit signal in a transmission mode. The duplexer 103 transmits the signal fed from the PA 101 over an antenna in the transmission mode, and provides a signal received on the antenna to the switch 105 in a reception mode. For example, the duplexer 103 can be implemented as a circulator.

The switch 105 passes a signal by operating in ON state only in the reception mode so as to block the signal fed to the receive circuit in the transmission mode. The signal fed to the receive circuit (e.g., LNA 107) in the transmission mode is caused by a reflected wave generated when the duplexer 103 malfunctions or the duplexer 103 is not completely matched with the antenna. For example, the switch 105 can be implemented using Single Pole Double Throw (SPDT). To protect the receive circuit, a stub can be used instead of the switch 105. The LNA 107 amplifies the receive signal weakened after passing through the radio channel and outputs the amplified receive signal.

As discussed above, to protect the receive circuit in the TDD wireless communication system, the receive circuit protector (e.g., a switch or a stub) is positioned in the input stage of the LNA of the receiver. When the weak signal before the amplification of the receive circuit passes through the protector, noise is added to the receive signal. Hence, the noise increases the required receive signal strength at the antenna. However, to increase the receive signal strength, the communication distance with the other party needs to be shortened because the transmit power of the other party receiving the signal is limited. In other words, the receive circuit protector causes the deteriorated noise characteristics of the receiver and the reduced system cell coverage.

### SUMMARY OF THE INVENTION

To address the above-discussed deficiencies of the prior art, an aspect of the present invention is to substantially solve at least the above problems and/or disadvantages and to provide at least the advantages below. Accordingly, an aspect of the present invention is to provide an apparatus and method for protecting a receive circuit by enhancing noise characteristics of a receiver in a TDD wireless communication system.

Another aspect of the present invention is to provide an apparatus and method for protecting a receive circuit using an inverter circuit in a TDD wireless communication system.

The above aspects are achieved by providing a communicator in a TDD wireless communication system, which includes a generator for generating a control signal to activate a first amplifier; the first amplifier for receiving an activation signal from the generator; an inverter for inverting the control signal; and a second amplifier for receiving an activation signal from the inverter.

According to one aspect of the present invention, a method for protecting a receive circuit of a communicator of a TDD wireless communication system includes generating a control signal to control a first amplifier; activating the first amplifier using the control signal; and inactivating a second amplifier by inverting the control signal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a conventional communicator in a TDD wireless communication system;

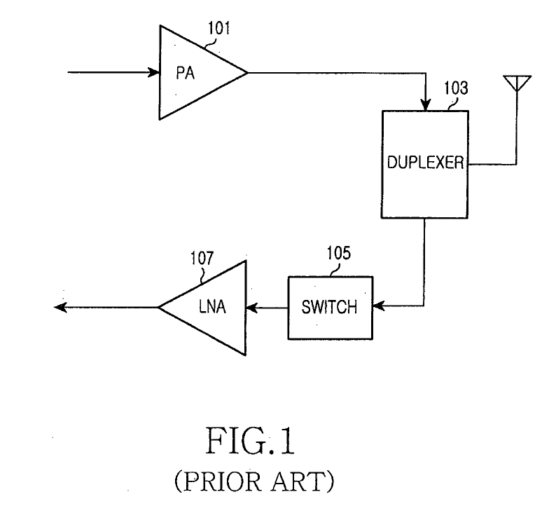

FIG. 2 is a block diagram of a communicator in a TDD wireless communication system according to the present invention; and

FIG. 3 is a flowchart of a method for protecting a receive circuit of the communicator in the TDD wireless communication system according to the present invention.

### DETAILED DESCRIPTION OF THE PREFERRED EMBODIMENTS

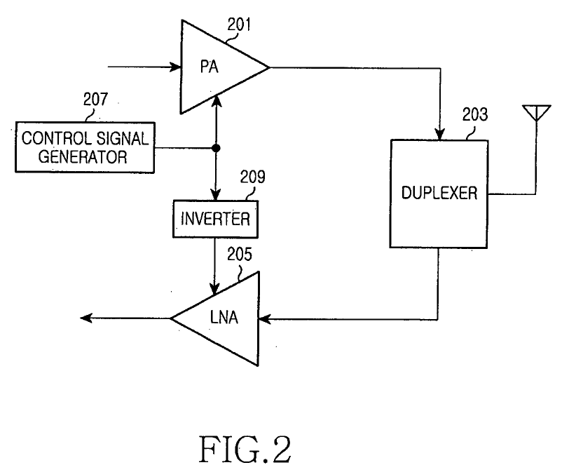

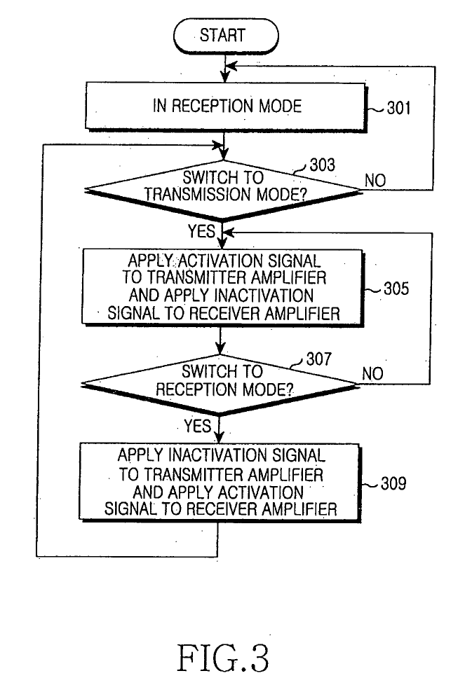

FIGS. 2-3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides a technique for improving noise characteristics of a receiver and protecting a receive circuit in a Time Division Duplex (TDD) wireless communication system.

FIG. 2 is a block diagram of a communicator in a TDD wireless communication system according to the present invention. The communicator of FIG. 2 includes a Power Amplifier (PA) 201, a duplexer 203, a Low Noise Amplifier (LNA) 205, a control signal generator 207, and an inverter 209.

The PA 201 amplifies a transmit signal and outputs the amplified transmit signal in a transmission mode. According to the present invention, the PA 201 is activated upon receiving a control signal in the transmission mode and inactivated upon receiving a control signal in a reception mode.

The duplexer 203 transmits the signal fed from the PA 201 over an antenna in the transmission mode, and provides a signal received on the antenna to the LNA 205 in the reception mode. For example, the duplexer 203 can be implemented using a circulator.

The LNA 205 amplifies the receive signal weakened after passing through a radio channel and outputs the amplified receive signal. According to the present invention, the LNA 205 is inactivated upon receiving a control signal in the transmission mode and activated upon receiving a control signal in the reception mode.

The control signal generator 207 generates a control signal to activate or inactivate the PA 201 and the LNA 205 depending on the transmission or reception mode. The inverter 209 inverts the control signal of the PA 201, which is output from the control signal generator 207, and provides the inverted control signal to the LNA 205. That is, the inverter 209 inverts the control signal so that the PA 201 and the LNA 205 operate inversely all the time.

The inverter 209 of FIG. 2 is positioned at the input phase of the LNA 205. When the inverter 209 is positioned at the input phase of the PA 201 and the control signal generator 207 issues a control signal for the LNA 205, the same effect can be achieved.

FIG. 3 is a flowchart of a method for protecting a receive circuit of the communicator in the TDD wireless communication system according to the present invention. In FIG. 3, the communicator is in the reception mode in step 301. That is, the transmitter amplifier is inactivated and the receiver amplifier is activated.

The communicator checks whether to switch to the transmission mode in step 303. In the transmission mode, the communicator applies an activation signal to the transmitter amplifier and applies an inactivation signal to the receiver amplifier at the same time in step 305. Accordingly, the receiver amplifier is turned off and causes high impedance, and the high power signal of the transmitter is not fed to the receive circuit.

In step 307, the communicator checks whether it is switched to the reception mode. In the reception mode, the communicator applies an inactivation signal to the transmitter amplifier and applies an activation signal to the receiver amplifier at the same time in step 309.

As set forth above, by protecting the receive circuit using the inverter circuit in the TDD wireless communication system, the noise characteristics of the receiver can be improved compared to the conventional receive circuit protection.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communicator in a Time Division Duplex (TDD) wireless communication system, comprising:
a generator for generating a control signal to activate a first amplifier;
the first amplifier for receiving an activation signal from the generator;
an inverter for inverting the control signal; and
a second amplifier for receiving an inactivation signal from the inverter.

2. The communicator of claim 1, wherein the first amplifier is a Power Amplifier (PA) which amplifies a transmit signal, and
the second amplifier is a Low Noise Amplifier (LNA) which amplifies a receive signal.

3. The communicator of claim 1, wherein the generator outputs a control signal for activating the first amplifier in a transmission mode, and
the generator outputs a control signal for inactivating the first amplifier in a reception mode.

4. The communicator of claim 1, wherein the inverter inverts a inactivation signal to inactivate the first amplifier and applies to the second amplifier activation signal.

5. A method for protecting a receive circuit of a communicator of a Time Division Duplex (TDD) wireless communication system, the method comprising:
generating a control signal to control a first amplifier;
activating the first amplifier using the control signal; and
inactivating a second amplifier by inverting the control signal.

6. The method of claim 5, wherein the first amplifier is a Power Amplifier (PA) which amplifies a transmit signal, and
the second amplifier is a Low Noise Amplifier (LNA) which amplifies a receive signal.

7. The method of claim 5, wherein the control signal generating step comprises:
generating a control signal to activate the first amplifier in a transmission mode; and
generating a control signal to inactivate the first amplifier in a reception mode.

8. The method of claim 5, further comprise;
inverting a inactivation signal to inactivate the first amplifier; and
applying to the second amplifier activation signal.

9. A wireless communication system comprising at least one transceiver that communicates in a Time Division Duplex (TDD) scheme, the at least one transceiver comprising:
a first amplifier for amplifying an outgoing signal via an antenna during a transmission period;
a second amplifier for amplifying a received signal received by the antenna during a receive period;
a duplexer for coupling an output of the first amplifier to the antenna and coupling an input of the second amplifier to the antenna;
a controller for generating a control signal to activate one of the first and second amplifiers while substantially simultaneously deactivating the other of the first and second amplifiers.

10. The wireless communication system of claim 9, wherein the first amplifier is a power amplifier and the second amplifier is a low-noise amplifier.

11. The wireless communication system of claim 9, wherein the controller comprises:
a signal generator that outputs a first control signal that activates and deactivates the first amplifier; and
an inverter for inverting the first control signal from the signal generator to produce a second control signal that activates and deactivates the second amplifier.

12. The wireless communication system of claim 9, wherein the controller comprises:
a signal generator that outputs a first control signal that activates and deactivates the second amplifier; and
an inverter for inverting the first control signal from the signal generator to produce a second control signal that activates and deactivates the first amplifier.

13. For use in a wireless communication system comprising at least one transceiver that communicates in a Time Division Duplex (TDD) scheme, a method of operating the transceiver comprising the steps of:
during a transmission period, amplifying in a first amplifier an outgoing signal for transmission via an antenna;
during a receive period, amplifying in a second amplifier a received signal received by the antenna;
generating control signals that selectively activate one of the first and second amplifiers while substantially simultaneously deactivating the other of the first and second amplifiers.

14. The method of claim 13, wherein the first amplifier is a power amplifier and the second amplifier is a low-noise amplifier.

15. The method of claim 13, wherein the step of generating control signals comprises the sub-steps of:
generating a first control signal that activates and deactivates the first amplifier; and
inverting the first control signal to produce a second control signal that activates and deactivates the second amplifier.

16. The method of claim 13, wherein the step of generating control signals comprises the sub-steps of:
generating a first control signal that activates and deactivates the second amplifier; and
inverting the first control signal to produce a second control signal that activates and deactivates the first amplifier.
